(19) United States
(12) Patent Application Publication
(10) Pub. No.: US 2003/0138069 A1
(43) Pub. Date: Jul. 24, 2003

(54) Device permitting the modulation of absorption, emission, moderation or reflection of radiation or a particle flow

(76) Inventor: Michel Emin, Ecully (FR)

Correspondence Address: PEARNE & GORDON LLP, 526 SUPERIOR AVENUE EAST, SUITE 1200, CLEVELAND, OH, 44114-1484, US

(21) Appl. No.: 10/283,623

(22) Filed: Oct. 30, 2002

Related U.S. Application Data
(62) Division of application No. 09/462,216, filed on Mar. 10, 2000, now abandoned.

(30) Foreign Application Priority Data
Jul. 7, 1997 (FR) 97 08818

(51) Int. Cl. G21C 7/06

(52) U.S. Cl. 376/221

(57) ABSTRACT

A device comprising a bundle of channels (8, 23), tubes or similar units permanently is arranged in the reactor and designed to contain a neutrophage fluid that absorbs neutrons.

In addition, this device comprises means that allow one to vary the number of absorbing channels (8, 23) as a function of the desired modulation.

### DESCRIPTION

The subject of this invention is a device allowing one to modulate the absorption, emission, or reflection of radiation or a particle flow, for example, a neutron flow, with the aim, for example of adjusting the reactivity of a nuclear system, to make it safe or to contain ionizing radiation, for example, from a reactor, a fuel pile, or a radioactive material storage system, a system that is potentially radioactive or one that is to be subjected to irradiation.

FIG. 1 of the appended diagrammatic drawings shows a view in longitudinal section of a nuclear reactor. In such a reactor, in the reactor vessel, which is designated by reference number 2, the radioactive elements 3 are arranged in the form of vertical piles between which there are voids. Absorption of the neutron flow, in order, for example to shut down the installation, is provided using control rods 4, arranged above the radioactive elements. These control rods 4 are intended to be inserted into the spaces between the radioactive elements in order to absorb the neutron flow. The result is that the height of the reactor vessel has to be very high in order to permit the displacement of the control rods between a position in which they are arranged between the radioactive elements and a position in which they are arranged above them. The other disadvantages of this technique reside:

on the one hand, in the dangers associated with the risk of a control rod being jammed, the skipping of a step by the control rod command mechanism and the non-descent of a control rod when there is an emergency shut-down of a reactor, and

on the other hand, in the difficulties in operating nuclear installations due to unequal wastage of the fuel and asymmetry of the neutron flow resulting notably from the poisoning of the fuel and the xenon samarium effect.

These latter points necessitate the use of boron in order to regulate the reactivity and lead to imperfect fuel consumption.

Furthermore, this technology, being sensitive to movements and accelerations, poses problems in the case of mobile installations or when installations are put on board ships or into submarines.

Documents GB 803 701, FR 1 269 659 and DE 1125562 describe devices for modulating the nuclear power of a reactor, using a grid of tubes containing a liquid that absorbs neutrons. In the different cases, the modulation is provided by causing the level of the liquid that absorbs neutrons to vary. The result is a deformation of the axial neutron flow.

The purpose of the invention is to provide a device of simple and compact structure, that allows one to modulate the nuclear power of a reactor or the absorption of particles without deformation of the axial neutron flow, and by providing homogeneity of absorption of the neutrons.

On this purpose, the device to which it relates, of the type comprising a bundle of channels, tubes or similar units arranged permanently within the reactor and designed to contain a neutrophage fluid absorbing the neutrons, is characterized in that it comprises means that permit one to vary the number of absorbing channels as a function of the desired modulation.

Each channel containing a neutrophage fluid is either in the position of being entirely filled or in the position of being entirely empty, it being possible for the different channels to be filled or emptied in a differentiated fashion, independently or through a series of channels. It is therefore possible to modulate the power of a reactor, without deformation of the axial neutron flow. According to another form of implementation, the channels, containing the neutrophage fluid remain permanently full, and are connected to channels intended to form the screen, which can be filled or not, on command by a liquid that reflects neutrons. The filling or not of a certain number of channels by a liquid that reflects neutrons permits modulation of the power of the reactor.

This solution is of particular interest if one wishes to provide safety means to bring about the rapid shutdown of the reaction, this shutdown being obtained by a simultaneous emptying of all the channels containing the liquid that reflects neutrons.

According to one characteristic of the invention, the neutrophage fluid comprises at least one liquid metal charged with particles of materials that absorb or reflect neutrons and having the same density as the liquid. This arrangement allows one to provide absorption or reflection that is neutronically homogeneous.

According to one characteristic of the invention, the particles of materials that absorb or reflect neutrons are obtained by alloying or sintering.

Advantageously the neutrophage fluid is chosen from among the following compositions:

Cadmium and micro-spheres of molybdenum monoboride (MoB) of the same density as the cadmium (8.65);

A mixture of indium/cadmium, tin/cadmium or tin/indium/cadmium adjusted to the density of samarium (7.54);

A mixture of indium/cadmium, tin/cadmium or tin/indium/cadmium adjusted to the density of gadolinium (7.895);

Liquid cadmium to which is added micro-spheres of tungsten boride W₂B₅, alloyed by sintering with a indium-silver alloy.

According to another characteristic of the invention, the liquid that reflects neutrons and which is used to supply the channels forming screens, is chosen from among mixtures containing heavy water D₂O or other hydrogenated liquids, possibly charged with particles such as beryllium that reflect neutrons. This reflecting liquid can be used in association with an absorbent fluid that has one of the preceding compositions or is based on Hf or Hf diboride.

The various absorbing channels can be filled with the same neutrophage liquid or with different neutrophage liquids, they can have the same section, constant or not, or have different sections.

These different possibilities allow one to perfectly match the modulation device to the reactor to which it is to be fitted, which can be an a reactor that already exists.

According to one possibility, the channels are each made up of a U-shaped tube or by two concentric tubes that communicate at one of their ends, the filling with fluid being carried out by a pneumatic device, a source of vacuum, or a device for circulating the fluid by pump or by piston.

The corresponding ends of several parallel tubes can be connected to one and the same channel, one of the ends of each channel containing the fluid being connected to a flask fitted with two swan necks, with the purpose of preventing untimely emptying of liquid and to ensure its stability with regard to temperature variations in the reactor. In the case of a reservoir inside the reactor vessel which, as a consequence, is subjected to neutron bombardment, it is important to provide a screen that reflects the neutrons in order to preserve the effectiveness of the liquid.

According to one form of implementation, this device additionally comprises channels, intended to receive a fluid containing a radioactive element placed under conditions that permit transmutation of this element to another radioactive element.

It is possible to integrate a transmutation channel without generating an imbalance in the neutron flow. It is advisable to control the neutron flow received by the channel containing the material to be transmuted, by integrating a local neutron measuring system which can be provided outside the reactor and carry out the absorption measurement for the materials contained either in the transmutation channel, or in a channel close to it.

Thanks to the ability to modulate by absorption or reflection, this installation allows one to adapt the neutron flow to carry out the transmutation operation.

It is possible to carry out control operations to periodically check the effectiveness of the absorbent fluid or fluids. A certain quantity of fluid is removed and the particles are recovered by filtration or centrifugation, or chemical or magnetic separation.

In any case, the invention will be well understood with the help of the description which follows, that refers to the appended drawings which represent, by way of non-limitative examples, several embodiments of this device.

FIG. 1 is a cross section view of a traditional nuclear reactor,

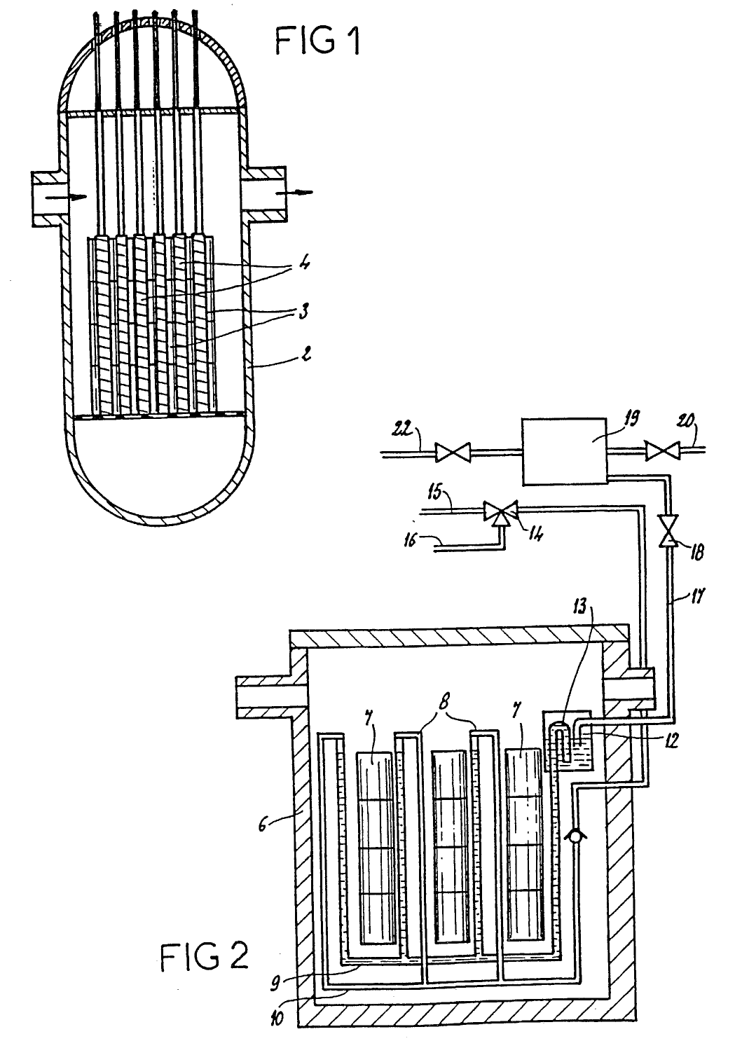

FIG. 2 is a very diagrammatic view, in section, of a nuclear reactor according to the invention,

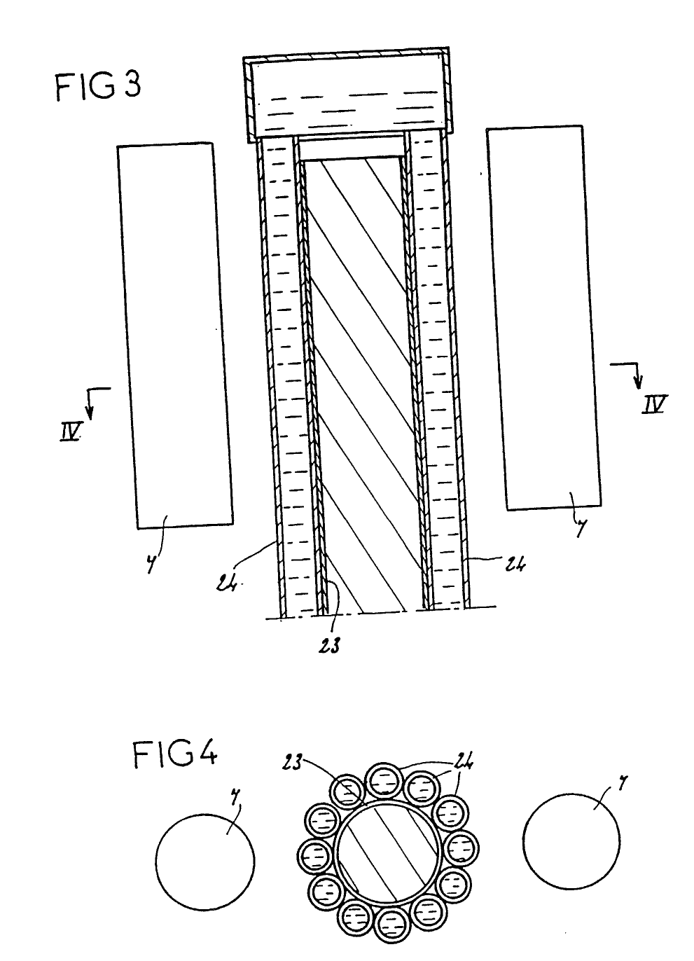

FIG. 3 is a longitudinal section view of a channel containing a neutrophage fluid and of two channels forming a screen,

FIG. 4 is a transverse section view of these channels along the line IV-IV of FIG. 3,

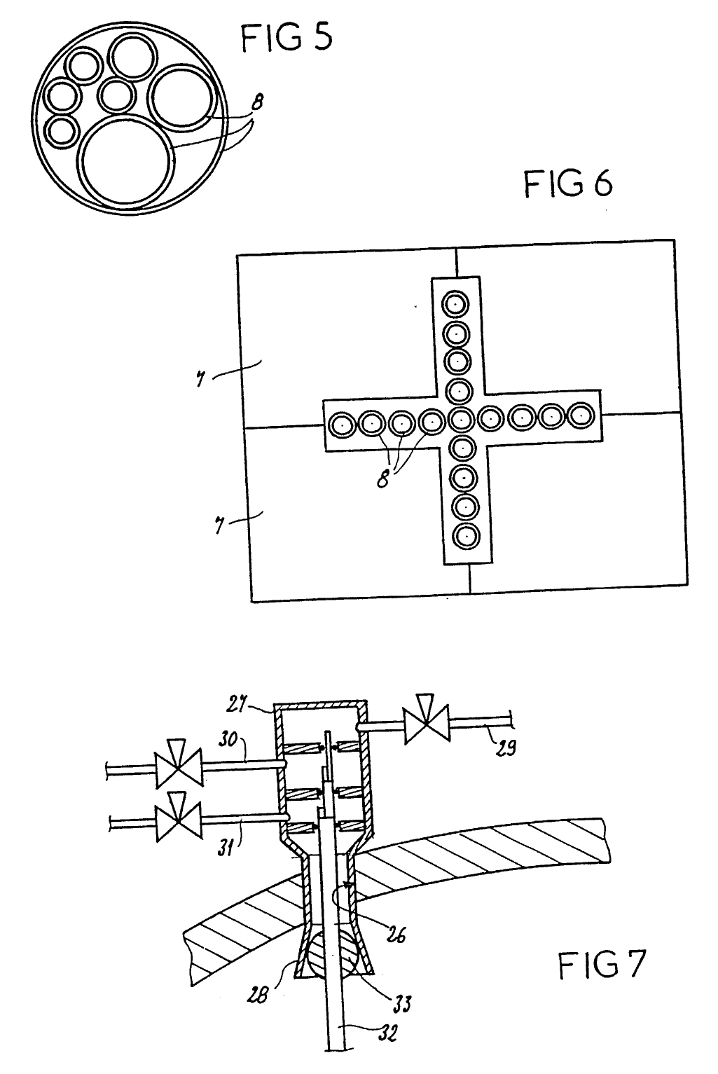

FIGS. 5 and 6 are two views illustrating two ways of assembling channels containing a neutrophage fluid,

FIG. 7 is a highly diagrammatic view, in section, of a device that passes through the cover of a reactor vessel.

FIG. 2 represents in a very diagrammatic way, a nuclear reactor that comprises a vessel 6, inside of which, vertical piles 7 of fuel material are arranged, between which, there are free spaces.

Between the piles of fuel material a bundle of channels 8 is inserted in the form of U-shaped pins, first ends of the pins 8 being connected to a channel 9 and second ends of the pins 8 being connected to a channel 10. The pins 8 and the channels 9 and 10 form a circuit inside which circulates a neutrophage fluid, made up, for example, of liquid cadmium, to which are added micro-spheres of tungsten boride W₂B₅, alloyed by sintering with the indium-silver alloy.

The channel 9 is connected through a swan neck, which forms a siphon 12, to a pressurized flask 13 situated inside the reactor vessel, which ensures that the temperature of the fluid is maintained. The flask could be situated outside the vessel, but should be heated in such a case. As for channel 10, it is connected through a three-way electronically controlled valve 14 on the one hand, to a source of pressurized air 15, and on the other hand to the open air 16. As for the flask 13, it communicates through the channel 17, the end of which is fitted with a swan neck, and on which an electronically controlled valve 18 is mounted, with a device 19 for analyzing fluids, from which the fluids can be sent through pipes 20, 22 to devices which treat it or replace it.

When the electronically controlled valve 14 permits the admission of pressurized air, the pressure causes the neutrophage fluid to rise inside the flask 13, and the channels 8 start to empty. In order to keep these channels filled, which is the aim of the invention, it is advisable to switch the electronically controlled valve 18 into the position in which it puts the channels into communication with the exhaust 16. Because the pressure is falling, the neutrophage fluid is driven by the pressure prevailing in the flask and fills the channels.

FIG. 2 only shows one group of channels 8. It is possible to have several groups of channels available, the channels being controlled independently of one another in order to be independently filled or emptied, which allows one to create a different modulation in different parts of the reactor.

The modulation of the power of the reactor is obtained by varying the number of groups of channels which are filled and emptied. The reactor shuts down when all the channels are filled with neutrophage fluid. Variation of power is obtained by keeping certain channels full while others are empty.

FIGS. 3 and 4 represent a variant in the use of this device. In this form of use, a channel 23 is permanently full of neutrophage fluid. This channel 23 is surrounded by channels 24 that may or may not be filled with a fluid that reflects the neutrons.

When all the channels 24 are filled, there is no absorption by the fluid contained in channel 23. When one is seeking modulation, it is possible to empty certain of the channels 24 in order to allow absorption by the fluid contained in channel 23. In order to command the shutdown of the reactor, it is advisable to empty all the channels 24 simultaneously and totally.

FIGS. 5 and 6 show two ways of arranging channels 8 containing a fluid that absorbs the neutrons. In the arrangement of FIG. 5, the channels are grouped together in series and different channels have different sections. In the arrangement shown in FIG. 6, the channels are arranged in a cross, and can be grouped together in groups of two or more, to form U-shaped pins.

In a highly diagrammatic way, FIG. 7 shows a cover 25 of a reactor vessel that includes an opening 26, through which passes a component 27 which is bell-shaped, the lower part 28 of which is flared and situated inside the vessel. This bell is used for the passage of tubes 29, 30, 31 that provide the circulation of the neutrophage and/or reflecting fluids, the cover of the vessel being penetrated by a multi-channel tube 32, guided by a sphere 33 situated on the inside of the flared part of the bell 27.

As is apparent from what has gone before, the invention offers a great improvement to the existing technique by providing a device with a simple structure that avoids any mechanical action when regulating the nuclear power of a reactor, a device which occupies a small volume and which is highly reliable.

Obviously, the invention is not limited to the embodiments of this device described above by way of examples, but on the contrary embraces all variants. It should be noted that the arrangement of the different channels inside the reactor may be different from the arrangements shown and that the means of circulating the fluid that absorbs the neutrons or the fluid that reflects the neutrons could be different and may be obtained either through a vacuum source or through a circulation device that uses a pump, a piston or an intermediate command fluid, without departing from the scope of the invention.

1. Device that allows one to modulate the nuclear power of a reactor or the absorption of particles without deformation of the axial neutron flow, comprising a bundle of channels (8, 23), tubes or similar components, permanently arranged within the reactor and intended to contain a neutrophage fluid that absorbs the neutrons, characterized in that it comprises means that permit one to vary the number of absorbing channels (8, 23) as a function of the desired modulation.

2. Device according to claim 1, characterized in that it comprises means that permit one, on command, to empty or to fill totally, each channel (8) with a neutrophage fluid.

3. Device according to claim 1, characterized in that it comprises channels (23) forming screens which, associated with the channels (23) containing the neutrophage fluid which remain permanently filled, can be filled, on command, with a liquid that reflects neutrons.

4. Device according to any one of claims 1 to 3, characterized in that the neutrophage fluid comprises at least one liquid metal charged with particles of materials with the same density as the liquid, that absorb or reflect the neutrons.

5. Device according to claim 4, characterized in that the particles of materials that absorb or reflect the neutrons are obtained by alloying or sintering.

6. Device according to any one of claims 4 and 5, characterized in that the neutrophage fluid is chosen from among the following compositions;
Cadmium and micro-spheres of molybdenum monoboride (MoB) of the same density as the cadmium (8.65);
A mixture of indium/cadmium, tin/cadmium or tin/indium/cadmium adjusted to the density of samarium (7.54);
A mixture of indium/cadmium, tin/cadmium or tin/indium/cadmium adjusted to the density of gadolinium (7.895);
Liquid cadmium to which is added micro-spheres of tungsten boride W₂B₅, alloyed by sintering with a indium-silver alloy.

7. Device according to claim 3, characterized in that the liquid that reflects the neutrons and which is intended to be supplied to the channels (24) that form screens, is chosen from among mixtures containing heavy water D₂O or other hydrogenated liquids, possibly charged with particles such as beryllium, that reflect neutrons.

8. Device according to any one of claims 1 to 7 characterized in that all the channels (8, 23) are filled with the same neutrophage liquid.

9. Device according to any one of claims 1 to 7, characterized in that the channels (8, 23) are filled with different neutrophage liquids.

10. Device according to any one of claims 1 to 9, characterized in that all the channels (8, 23) filled with neutrophage liquid, have the same section.

11. Device according to any one of claims 1 to 9, characterized in that the channels (8, 23) filled with neutrophage liquid, have different sections.

12. Device according to any one of claims 1 to 11, characterized in that the channels (8, 23) are each made up of a tube in the shape of a U or by two concentric tubes that communicate at one of their ends, which are filled with fluid by a pneumatic device (15), a source of vacuum, or a device for circulating the fluid by pump or piston.

13. Device according to any one of claims 1 to 12, characterized in that the corresponding ends of several parallel channels (8) are connected to one and the same channel (9, 10).

14. Device according to any one of claims 1 to 12, characterized in that one of the ends of each channel (9) containing fluid is connected to a flask (13) fitted with two swan necks with the purpose of preventing untimely emptying of liquid and to ensure stability of the flask with respect to temperature variations in the reactor.

15. Device according to any one of claims 1 to 14, characterized in that it comprises, in addition, channels intended to receive a fluid containing a radioactive element placed under conditions that permit transmutation of this element into another radioactive element.
